(19) United States
(12) Patent Application Publication
(10) Pub. No.: US 2025/0322427 A1
(43) Pub. Date: Oct. 16, 2025

(54) SYSTEMS AND METHODS FOR DEPLOYING A VIRTUAL-REALITY CAMPAIGN USING AN INTERACTIVE DASHBOARD

(71) Applicant: Qubi, Inc., Irvington, NY (US)

(72) Inventors: Catherine D. PALMIERI, Irvington, NY (US); Samuel D. DILLENER, Oakton, VA (US); Roger W. FERGUSON, JR., North Palm Beach, FL (US)

(73) Assignee: Qubi, Inc., Irvington, NY (US)

(21) Appl. No.: 18/631,876

(22) Filed: Apr. 10, 2024

(51) Int. Cl. G06Q 30/0242

(52) U.S. Cl. CPC G06Q 30/0246

(57) ABSTRACT

Systems and methods for deploying a VR campaign using an interactive dashboard are provided. The dashboard can detect user inputs associated with specifying one or more of an interactive activity associated with the VR campaign, a time metric, a location metric, a display metric, and/or a reward metric to engage with users. The dashboard can be displayed on a merchant device that is in wireless communication with user devices. The dashboard can transmit, to the user devices, instructions for deploying the VR campaign by rendering VR visualizations on the user devices. The dashboard can receive, from the user devices, user engagement data associated with the deployed VR campaign and generate analytics visualizations based on the user engagement data. Thus, using the interactive dashboard, merchants can receive and monitor user engagement analytics associated with the campaign, and/or adjust various campaign settings in real-time to account for user engagement.

### FIELD OF THE DISCLOSURE

This invention relates generally to a system and methods for configuring a virtual-reality system, and more particularly, to systems and methods for deploying a virtual-reality campaign using an interactive dashboard.

### BACKGROUND OF THE DISCLOSURE

With the rise of digital shopping, traditional brick-and-mortar businesses struggle to generate foot traffic and sales. Many merchants thus turn to advertisement campaigns to increase foot traffic to brick-and-mortar stores. Recently, virtual- or augmented-reality platforms have proven to be effective drivers of foot traffic to a given area. For example, Pokémon Go™, a gaming application in which players travel within an augmented-reality version of the real world to collect virtual monsters via a user interface on a mobile device, has driven many players to visit real-world locations where the game indicates virtual monsters are located. Similarly, virtual-reality advertisement campaigns, in which merchants offer users rewards based on user behaviors (e.g., visiting certain real-world locations), can engage potential customers and drive foot traffic to brick-and-mortar stores.

### SUMMARY OF THE DISCLOSURE

Virtual-reality advertisement platforms provide merchants with a virtual means of interaction with users and bring foot traffic to brick-and-mortar stores. To maximize the efficiency of an advertisement campaign, merchants must effectively target and engage the appropriate customers. However, on current virtual-reality advertisement platforms, merchants lack the ability to sufficiently customize the campaign settings to account for user engagement. For example, merchants lack the appropriate analytics tools to gauge user engagement and precisely reconfigure the campaign settings to target the appropriate users. Thus, current campaigns can result in a large portion of the advertisement dollars of a given campaign spent reaching “non-target” customers, evidenced by only a small percentage of total sales being attributable to one or more advertisement campaigns.

As stated above, current virtual-reality advertisement platforms lack the ability for merchants to analyze user engagement and reconfigure advertisement campaign settings to target the appropriate users. Merchants struggle with drawing target customers to brick-and-mortar business locations and engaging with the customers to drive purchases at those locations. This can result in large portions of advertisement dollars being spent on non-target customers. Thus, there is a need for an improved virtual-reality advertisement platform that offers merchants the ability to adjust campaign settings in real-time to account for user engagement. A virtual-reality advertisement platform that provides merchants with an interactive dashboard for deploying a campaign and monitoring user engagement analytics associated with the campaign can allow merchants to more effectively target customers in an automation-assisted, precise, and dynamic manner. Accordingly, disclosed herein are systems and methods that can address some of the above-identified needs.

Disclosed herein are systems and methods for deploying a virtual reality (VR) campaign using an interactive dashboard. (Unless specified otherwise, the term virtual reality as used herein may be understood to optionally encompass augmented reality.) The dashboard may be provided via any suitable computing device, such as by being provided as a desktop application, mobile application, and/or or web-browser hosted application. The interactive dashboard can detect user inputs specifying an interactive activity associated with a VR campaign, a time metric for the VR campaign, a location metric for the VR campaign, a display metric for the VR campaign, and/or a reward metric for the VR campaign to engage with users. The interactive dashboard can be displayed on a computing device of a merchant system that is in wireless communication with one or more user devices. The interactive dashboard can be configured to transmit, to the user devices, instructions for deploying the VR campaign by rendering VR assets on the user devices. The interactive dashboard can be configured to receive, from the user devices, user engagement data associated with the deployed VR campaign based on user engagement with the VR assets. The interactive dashboard can be configured to generate analytics visualizations based on the user engagement data. Thus, using the interactive dashboard, merchants can receive and monitor user engagement analytics associated with the campaign, and/or adjust various campaign settings in real-time to account for user engagement.

According to some embodiments, an exemplary method for deploying an interactive virtual-reality campaign and monitoring analytics associated with the campaign can comprise: displaying, on a computing device accessible to a merchant, a graphical user interface; detecting a first user input on the graphical user interface, wherein the first user input specifies an interactive activity associated with the campaign; detecting a second user input on the graphical user interface, wherein the second user input specifies one or more of a time metric, a location metric, a display metric, and a reward metric; transmitting, based on the first user input and the second user input, one or more campaign instructions for rendering a virtual-reality visualization associated with the campaign on one or more user devices; receiving, from the one or more user devices, user engagement data associated with the campaign based on user engagement with the virtual-reality visualization; and generating, using the graphical user interface, one or more analytics visualizations associated with the campaign based on the user engagement data.

In some embodiments, the interactive activity comprises one or more of: interacting with an icon, playing a virtual-reality game, collecting a virtual-reality reward, viewing an advertisement, visiting a map location, scanning a visual code, responding to a poll, and responding to a quiz. In some embodiments, the interactive activity is associated with a real-world location.

In some embodiments, the method further comprises: detecting a third user input on the graphical user interface, wherein the third user input specifies a target demographic of the campaign. In some embodiments, transmitting the one or more campaign instructions comprises transmitting, based on the first user input, the second user input, and the third user input, the one or more campaign instructions to one or more user devices associated with the target demographic.

In some embodiments, the time metric comprises one or more of: a daypart, a campaign start date, a campaign end date, a campaign start time, a campaign end time, a reward collection start time, and a reward collection end time. In some embodiments, the location metric comprises one or more of: a map location, a merchant location, a visit limit for a location, a reward limit for a location, a latitude, a longitude, and a radius for reward collection. In some embodiments, the display metric comprises one or more of: an icon representing the campaign, text representing the campaign, an icon representing the activity, text representing the activity, a visual code, a notification, a countdown for a time limit, a timer, and a map. In some embodiments, the reward metric comprises one or more of: a reward type, a reward trigger, a follow-up reward, a reward price, a reward quantity, a reward to be provided to a user based on past purchasing behavior of the user, and a conversion rate between rewards and currency.

In some embodiments, the virtual-reality visualization associated with the campaign comprises at least a portion of one or more of: an advertisement, a map, a user icon, a merchant icon, a virtual-reality game, a poll, a quiz, a virtual-reality scavenger hunt, an interactive character, a collectible item, a digital wallet, a currency icon, a reward icon, a collectible icon, and a coupon.

In some embodiments, the second user input specifies an image to be uploaded, and wherein the image represents one or more of the campaign and a reward associated with the campaign.

In some embodiments, the method further comprises: updating one or more of the time metric, the location metric, the display metric, and the reward metric based on the user engagement data.

In some embodiments, the method further comprises: detecting a fourth user input on the graphical user interface, wherein the fourth user input is associated with selecting an analytics visualization of the one or more analytics visualizations associated with the campaign; and displaying, on the computing device accessible to the merchant, the selected analytics visualization based on the fourth user input.

In some embodiments, the one or more analytics visualizations comprise one or more of: a map, a graph, a table, a list, and a statistic.

In some embodiments, the user engagement data comprises one or more of: user time data, user location data, user purchase data, and user reward data. In some embodiments, the user time data comprises one or more of: time spent at a map location, frequency of visits to the map location, time spent walking between map locations, and time spent engaging with the interactive activity associated with the campaign. In some embodiments, the user location data comprises one or more of: number of visits to a map location, number of visits to new locations, and ratio of new visits to returning visits. In some embodiments, the user purchase data comprises one or more of: number of purchases at a map location, total profit from the purchases, and average cost of the purchases. In some embodiments, the user reward data comprises one or more of: number of rewards awarded, number of the rewards left over, type of the rewards awarded, and value of the rewards awarded.

In some embodiments, the method further comprises: detecting a fifth user input on the graphical user interface, wherein the fifth user input is associated with inputting a user access credential of the merchant; and verifying the access level of the merchant. In some embodiments, the method further comprises: if the access level exceeds a threshold access level, displaying, on the computing device accessible to the merchant, one or more additional analytics visualizations associated with a plurality of interactive virtual-reality campaigns. In some embodiments, the one or more additional analytics visualizations comprise one or more of: a budget breakdown for each campaign of the plurality of interactive virtual-reality campaigns, identifying information associated with the one or more user devices, a list of transactions associated with each campaign of the plurality of interactive virtual-reality campaigns, summary statistics for the plurality of interactive virtual-reality campaigns, and a ranking of the plurality of interactive virtual-reality campaigns.

According to some embodiments, an exemplary computer-based system for deploying an interactive virtual-reality campaign and monitoring analytics associated with the campaign can comprise: a computing device accessible to a merchant; one or more user devices; and one or more processors coupled to one or more memory devices, wherein the one or more memory devices include instructions that when executed by the one or more processors cause the computer-based system to: display, on the computing device, a graphical user interface; detect a first user input on the graphical user interface, wherein the first user input specifies an interactive activity associated with the campaign; detect a second user input on the graphical user interface, wherein the second user input specifies one or more of a time metric, a location metric, a display metric, and a reward metric; transmit, based on the first user input and the second user input, one or more campaign instructions for rendering a virtual-reality visualization associated with the campaign on the one or more user devices; receive, from the one or more user devices, user engagement data associated with the campaign based on user engagement with the virtual-reality visualization; and generate, using the graphical user interface, one or more analytics visualizations associated with the campaign based on the user engagement data.

According to some embodiments, an exemplary user device for rendering an interactive virtual-reality environment for an interactive virtual-reality campaign can comprise: one or more processors coupled to one or more memory devices, wherein the one or more memory devices include instructions that when executed by the one or more processors cause the user device to: receive one or more campaign instructions for generating a virtual-reality visualization associated with the campaign, wherein the campaign instructions specify one or more of an interactive activity, a time metric, a location metric, a display metric, and a reward metric; render, based on the campaign instructions, the interactive virtual-reality environment comprising the virtual-reality visualization; collect, based on user engagement with the virtual-reality visualization, user engagement data associated with the campaign; and transmit, to an external computing device, the user engagement data associated with the campaign.

According to some embodiments, an exemplary non-transitory machine-readable medium can be configured for deploying an interactive virtual-reality campaign and monitoring analytics associated with the campaign, and the non-transitory machine-readable medium can be configured to store instructions that, when executed by at least one processor of a computing device, cause the computing device to perform operations comprising: displaying a graphical user interface; detecting a first user input on the graphical user interface, wherein the first user input specifies an interactive activity associated with the campaign; detecting a second user input on the graphical user interface, wherein the second user input specifies one or more of a time metric, a location metric, a display metric, and a reward metric; transmitting, based on the first user input and the second user input, one or more campaign instructions for rendering a virtual-reality visualization associated with the campaign on one or more user devices; receiving, from the one or more user devices, user engagement data associated with the campaign based on user engagement with the virtual-reality visualization; and generating, using the graphical user interface, one or more analytics visualizations associated with the campaign based on the user engagement data.

It will be appreciated that any of the variations, aspects, features and options described in view of the systems can be combined.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE FIGURES

Exemplary embodiments are described with reference to the accompanying figures, in which:

FIG. 1 depicts an exemplary computer-based system for deploying a virtual-reality campaign using an interactive dashboard, in accordance with some embodiments.

FIG. 2 depicts a method for a merchant to deploy a virtual-reality campaign using an interactive dashboard, in accordance with some embodiments.

FIG. 3 depicts an exemplary interactive dashboard configured to generate a virtual-reality map interface that can be displayed to a merchant, in accordance with some embodiments.

FIG. 4 depicts an exemplary interactive dashboard configured to generate analytics visualizations associated with the virtual-reality campaign based on user engagement data, in accordance with some embodiments.

FIG. 5A depicts an exemplary interactive dashboard that can be used by a merchant to configure one or more interactive activities for a virtual-reality campaign, in accordance with some embodiments.

FIG. 5B depicts an exemplary interactive dashboard that can be used by a merchant to configure one or more time metrics for a virtual-reality campaign, in accordance with some embodiments.

FIG. 5C depicts an exemplary interactive dashboard that can be used by a merchant to configure one or more location metrics for a virtual-reality campaign, in accordance with some embodiments.

FIG. 5D depicts an exemplary interactive dashboard that can be used by a merchant to configure one or more display metrics for a virtual-reality campaign, in accordance with some embodiments.

FIG. 5E depicts an exemplary interactive dashboard that can be used by a merchant to configure one or more reward metrics for a virtual-reality campaign, in accordance with some embodiments.

FIG. 6 depicts an exemplary computing device or system in accordance with one embodiment of the present disclosure.

### DETAILED DESCRIPTION OF THE DISCLOSURE

Disclosed herein are systems and methods for deploying a virtual-reality campaign using an interactive dashboard. The interactive dashboard can be associated with a virtual-reality (VR) advertisement platform that enables merchants to deploy VR advertisement campaigns. Using the interactive dashboard, merchants can receive and monitor user engagement analytics associated with the campaign, and/or adjust various campaign settings in real-time to account for user engagement. For example, merchants can adjust campaign settings associated with an interactive activity, a time metric, a location metric, a display metric, and/or a reward metric to engage with users. Thus, the interactive dashboard can allow merchants to more effectively engage with users who are the target customers of the campaign.

The VR advertisement platform can include an administrator server, one or more merchant systems, and one or more customer devices (also referred to herein as “user devices”). Each merchant system can include a computing device (also referred to herein as “merchant device”) that can wirelessly communicate with the administrator server and the one or more customer devices via a network. The interactive dashboard can include a graphical user interface (GUI) displayed on the computing device of the merchant system. A merchant can provide user inputs via the GUI in order to interact with the interactive dashboard. For example, the merchant may click, press, type, or otherwise interact with the GUI to adjust a setting or change an analytic displayed by the interactive dashboard.

Using the interactive dashboard, a merchant can configure the VR advertisement platform to distribute rewards based on user behavior. The merchant can deploy a VR advertisement campaign to offer virtual rewards to customers using an application on a customer device. The merchant can adjust campaign settings to specify, for example, an interactive activity associated with the VR advertisement campaign, the time and location at which the campaign will be active, how the campaign will be displayed in the application on the customer device, how the customer will be rewarded, and one or more target customers for the campaign.

While the campaign is active, customers may be provided with a virtual reward upon the completion of the interactive activity. For example, a virtual reward coupon can be collected by users who visit a specified geolocation and follow the appropriate instructions to collect the reward. A merchant can specify a coupon of a specific value is available to users who visit the brick-and-mortar business location of the merchant and scan a quick-response (QR) code located on a counter in the business location. As such, the interactive dashboard enables merchants to provide incentives for users to visit their business location and thus provides a new method for merchants to generate foot traffic.

User engagement data, such as how long a customer spends at a business location, and how frequently the customer completes activities and receives virtual rewards, can be transmitted from a customer device to the merchant device. User engagement data can be obtained based on user engagement with various VR assets of the VR advertisement campaign. This user engagement data can be presented to a merchant in the form of analytics visualizations, such as a graph or map. Using the interactive dashboard, the merchant can view analytics visualizations associated with each campaign. Based on the user engagement data, the merchant can decide to adjust certain campaign settings to change the campaign outcomes using the interactive dashboard. For example, the merchant can change the interactive activity associated with the campaign to increase engagement with customers of a certain age range who are more likely to be customers of the brick-and-mortar business location. Thus, the interactive dashboard enables merchants to more effectively engage with users who are the target customers of the campaign.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Disclosed herein are systems that may address one or more of the needs discussed above.

### VR Advertisement Platform

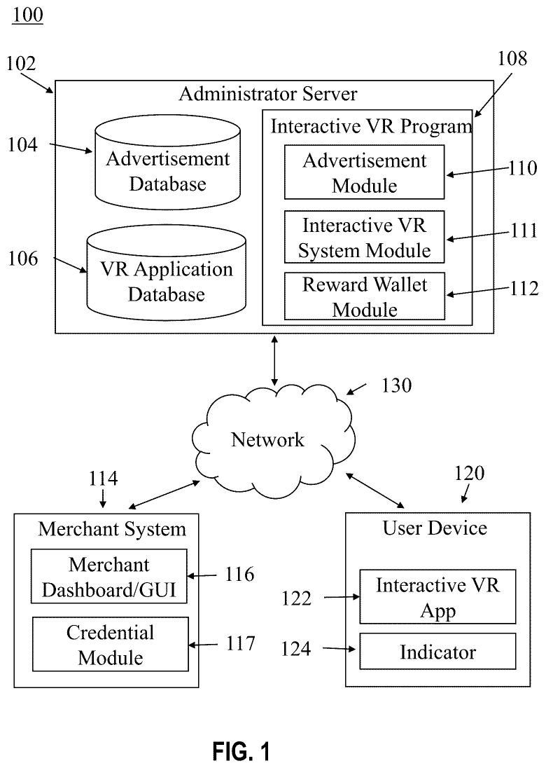

FIG. 1 depicts an exemplary computer-based system 100 for deploying a virtual-reality campaign on an interactive VR advertisement platform. Advertisers (also referred to herein as “merchants”) can use a merchant dashboard 116 on a computing device to interact with users (also referred to herein as “customers”) of the VR advertisement platform of system 100. In some embodiments, system 100 enables advertisers to create virtual icons and/or rewards and assign certain parameters for users to collect them within an interactive VR application 122. Users can explore a VR environment that may include a map with various icons corresponding to a given reward assigned by an advertiser. If the user satisfies the appropriate procedure to collect a reward, the user can elect to redeem the reward at the particular advertiser or to store a reduced value version of the reward for future use.

As shown, in some embodiments, system 100 can include an administrator server 102 that is connected to user device 120 and merchant system 114 over network 130. Administrator server 102 can house interactive VR program 108, advertisement database 104 and VR application database 106. Interactive VR program 108 can include advertisement module 110, interactive VR system module 111, and reward wallet module 112.

As used herein, “module” refers to computer logic that contains one or more routines that make up a sub-component of a broader computer program. A module can be implemented in hardware, firmware, and/or software controlling a general purpose processor. According to one embodiment, a module can include programming code stored on a storage device corresponding to the module that are loaded into memory and executed by a processor. In another embodiment, a module can be computer executable instructions stored in a tangible computer-readable storage medium.

Although only one user device 120 and one merchant system 114 are illustrated in FIG. 1, it should be understood that any number of user devices and any number of merchant systems can be connected to administrator server 102 over network 130. Merchant system 114 can include any computing device located at a given merchant location. Merchant system 114 may provide access to cloud services in order to receive and transmit information. User device 120 can be a mobile smartphone, a communication-enabled tablet or laptop, or any other mobile device capable of computation, storage, input, output, and display, that is similar to or superior to existing smartphones, tablets, and laptops.

According to some embodiments, administrator server 102 may be a virtual server in a virtual machine environment hosted by a third party. The virtual machine environment can include one or more processors and one or more memory devices in communication with an administrator device via network 130. A virtual administrator server may be configured to execute interactive VR program 108 using instruction contained in the one or more memory devices executed by the one or more processors. Alternatively, administrator server 102 can be any local computing device located at an administrator site. A local administrator server 102 can include a processor and a memory. The memory can store instructions that when executed by the processor cause the processor to perform operations.

Administrator server 102 can be in communication with advertisement database 104 and VR application database 106. In some embodiments, administrator server 102 can communicate with various user devices 120 within system 100 over a local public switched telephone network (PTSN) or telephone system using data transfers or other wireless protocol, such as SMS texts. Accordingly, administrator server 102 can still communicate with user device 120 when the user device is in a location with limited bandwidth or without broadband internet access.

In some embodiments, VR application database 106 can store data used in interactive VR program 108 to be provided to users on a user device 120 over network 130. The data stored in VR application database 106 can include data used in interactive VR program 108. For example, data used in interactive VR program 108 can include: (1) interactive map data, (2) user data, and (3) reward data. Interactive map data can include geographic coordinates of buildings and landmarks of a real-world area, geographic coordinates corresponding to virtual reward locations, imagery data to display a map of an area with virtual reward icons at each virtual reward location and an avatar representative of a user location within the map, etc. User data can include identifying information associated with each user of the VR application, a geographic location associated with the real-world location of each user, etc. Reward data can include icons associated with a given virtual reward, merchant-specific icons, general reward icons, information regarding how to collect a given reward and what type of reward is available from a given virtual reward, etc.

According to some embodiments, advertisement database 104 can store advertisement data supplied by merchants to be used in interactive VR program 108. In non-limiting examples, the data stored in advertisement database 104 may include: (1) merchant information, (2) advertisement campaign information, and (3) advertisement campaign metrics. Merchant information can include identifying information of a participating merchant such as a merchant logo, payment mechanisms, enrollment and contact information, etc. Advertisement campaign information for a given merchant can include advertisement parameters such as reward type, advertisement period, number of rewards available or total value of rewards available, etc. Advertisement campaign metrics for a given advertisement campaign can include return on investment information, frequency of reward redemption information, remaining campaign balance or period, number of unique users who have redeemed rewards, etc.

Advertisement data can be received from a merchant system 114 via network 130. In some embodiments, a merchant may specify information for a given advertisement using merchant dashboard 116 in merchant system 114. Merchant dashboard 116 can include a user interface implemented by advertisement module 110 that enables a given merchant to create an advertising campaign and specify advertisement parameters for the campaign to be delivered to users via interactive VR system module 111. In some embodiments, credential-based verification, as provided by credential module 117, may be used to restrict the advertising campaigns that a given merchant may access through the merchant dashboard 116. In some embodiments, the merchant system 114 can track user behaviors, such as time spent at a retail location, engagement, reward collection, and purchase behavior.

### Interactive Merchant Dashboard

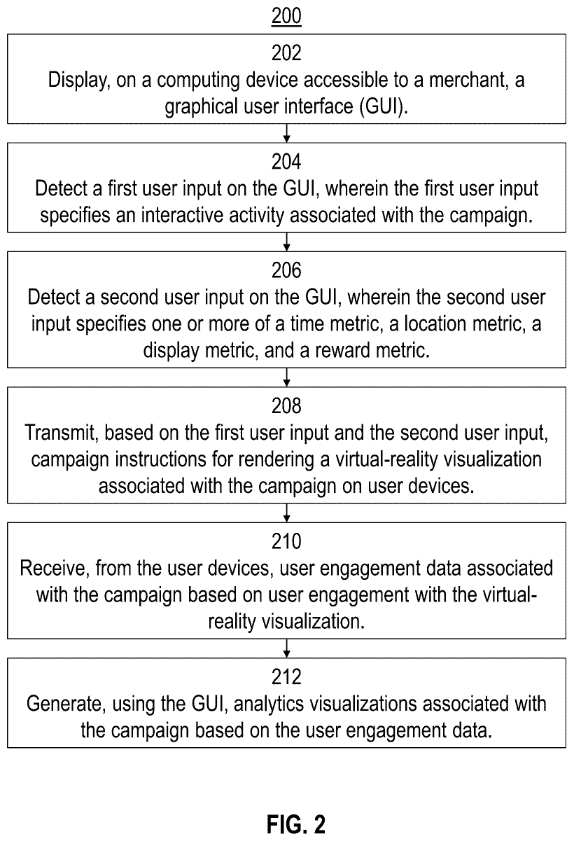

FIG. 2 depicts a method 200 for a merchant to interact with a VR program 108 to deploy a VR advertising campaign, in accordance with some embodiments. Using method 200, the merchant can deploy an interactive VR advertising campaign (e.g., at blocks 202-208) and monitor analytics associated with the campaign (e.g., at blocks 210-212). Method 200 can be implemented using a merchant dashboard in a merchant system in communication with an administrator server, such as merchant dashboard 116, merchant system 114, and administrator server 102 of system 100.

Prior to starting method 200, in some embodiments, a merchant can enroll to participate in an advertisement platform. A merchant may enroll using a merchant dashboard in a merchant system that is in communication with an administrator server, such as merchant dashboard 116, merchant system 114 and administrator server 102 of system 100. According to some embodiments, the advertisement platform can be implemented by advertisement module 110 of system 100. When enrolling, a merchant can provide certain identifying information such as contact information, merchant logo, geographic location, etc. The identifying information may be stored in a credential module such as credential module 117 of system 100.

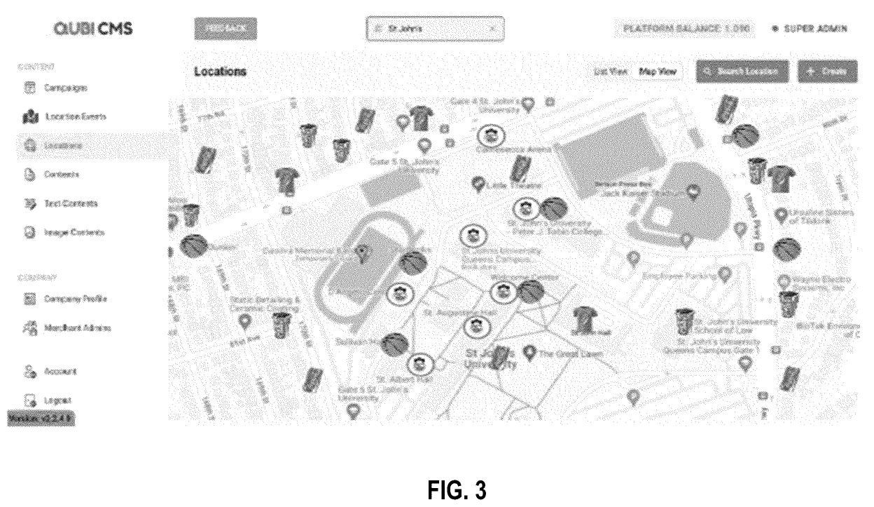

At block 202, in some embodiments, a merchant system 114 can display a merchant dashboard 116 to a merchant. The merchant dashboard 116 can include a graphical user interface (GUI) displayed on a computing device of the merchant system 114. A merchant can provide user inputs via the GUI in order to interact with the merchant dashboard 116. For example, the merchant may click, press, type, or otherwise interact with the GUI to adjust a setting or change an analytic displayed by the merchant dashboard 116. For example, FIG. 3 depicts an exemplary merchant dashboard 116 configured to generate a VR map interface that may be displayed to a merchant, in accordance with some embodiments. As shown in the figure, the merchant dashboard 116 can display a plurality of map icons at a plurality of merchant locations. Each map icon can be associated with an advertisement campaign. A merchant can monitor active campaigns and click on individual map icons to edit one or more settings associated with the campaign associated with the respective map icon. Furthermore, the merchant dashboard 116 can search for or scroll to different regions of the map to view additional map icons/merchant locations.

Referring back to FIG. 2, at block 204, in some embodiments, the merchant system 114 can detect a first user input via the merchant dashboard 116. The first user input can specify an interactive activity associated with the VR advertising campaign. In some embodiments, the interactive activity can include one or more of: interacting with an icon, playing a virtual-reality game, collecting a virtual-reality reward, viewing an advertisement, visiting a map location, scanning a visual code, responding to a poll, and responding to a quiz. For example, in system 100, users can explore a VR environment that may include a map with various icons corresponding to rewards assigned by an advertiser. Users can participate in the interactive activity by clicking on portions of the map, visiting real-world locations corresponding to locations on the map, etc. in an interactive VR app 122. Merchants can use the merchant dashboard 116 to configure how the interactive activity is accessed by the users.

In some embodiments, the interactive activity can have an association with a real-world location. For example, users can travel to real-world locations corresponding to virtual locations on the map, such as icons corresponding to businesses that are participating in the VR advertising campaign (e.g., by distributing rewards to users). At these real-world locations, users can interact with real-world objects, such as by filling out a form or scanning a real-world QR code with the interactive VR app 122, in order to complete the interactive activity and receive rewards.

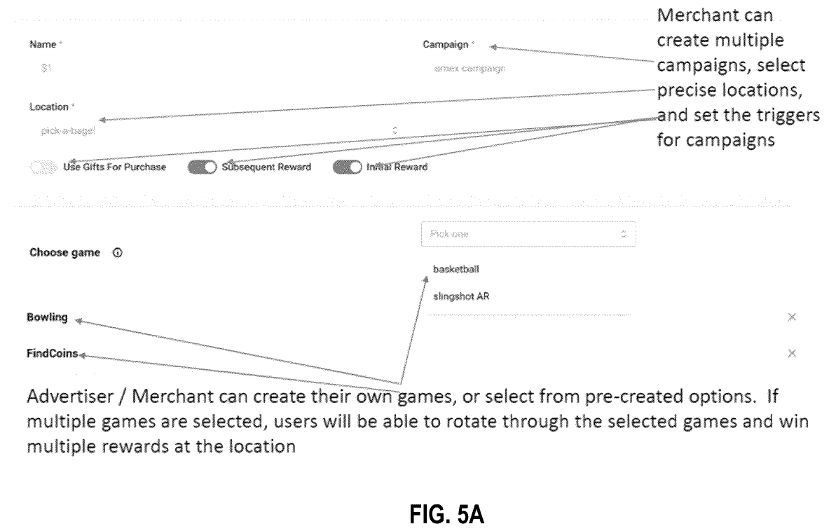

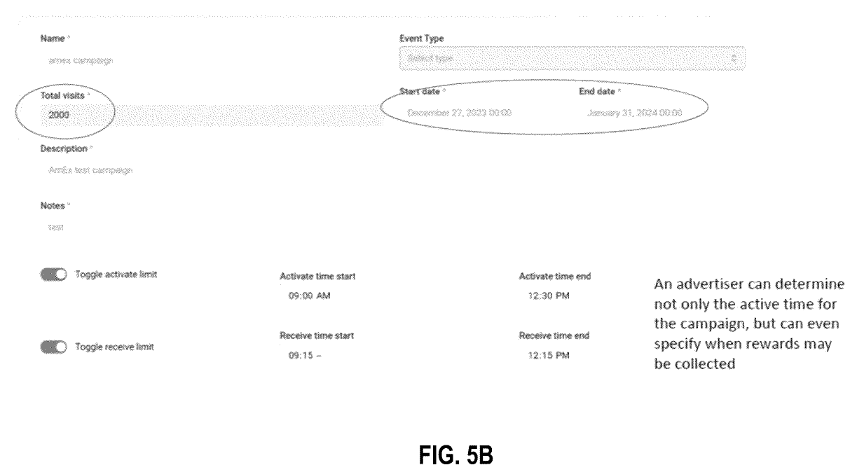

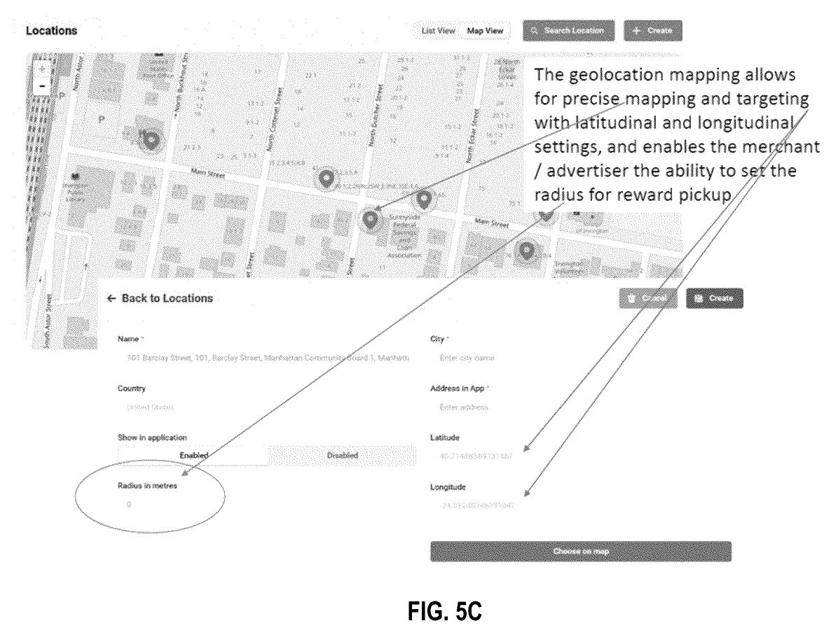

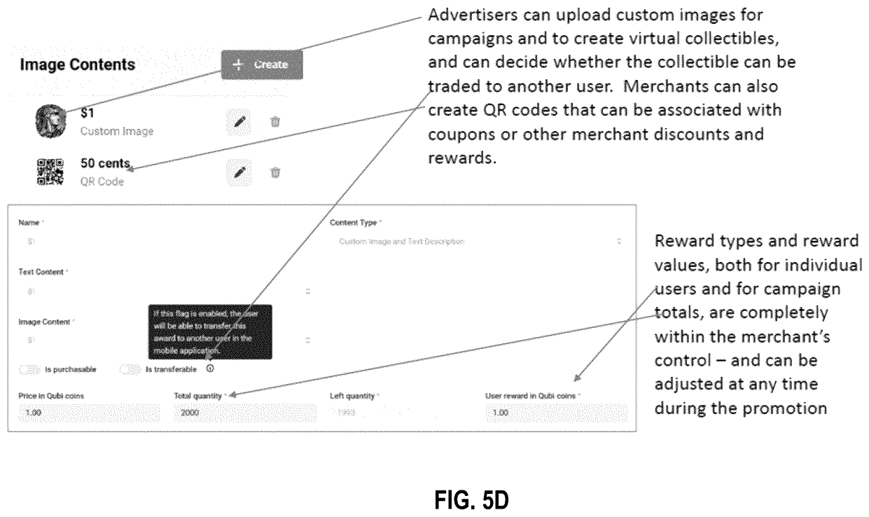

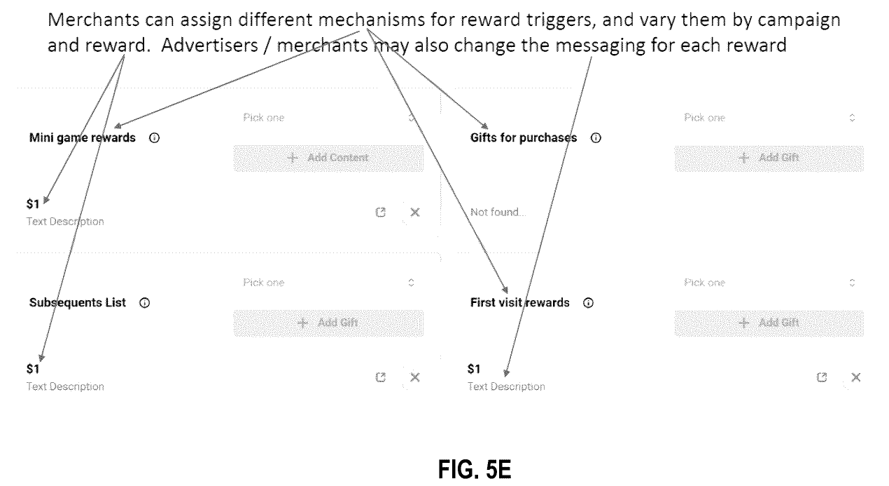

FIG. 5A depicts an exemplary merchant dashboard 116 that can be used by a merchant to configure the interactive activity for the VR advertising campaign, in accordance with some embodiments. As shown in the figure, a merchant can interact with the text boxes, drop-down menus, toggles, and buttons on the merchant dashboard 116 to select a name for the campaign, a map location for the activity to appear in the user's interactive VR app 122, how the activity will be triggered to appear, whether rewards will be distributed for completing the activity, and a VR game to be played in order to complete the activity. For example, the merchant can select “basketball” to generate a VR basketball game in the user's interactive VR app 122. The user can complete the activity by playing basketball for a threshold amount of time, by reaching a threshold point score, by competing against a virtual avatar representing a professional basketball player, etc. The merchant can also select “slingshot” to generate a VR slingshot in the user's interactive VR app 122. The user can complete the activity by hitting certain types or quantities of objects with slingshot pellets, shooting a slingshot pellet past a threshold distance, achieving a threshold accuracy in a slingshot shooting course, etc. In some embodiments, the merchant can create a game or, alternatively, select from pre-created options. If multiple games are selected, the user can rotate through the selected games and win multiple rewards for completing the activity.

Referring back to FIG. 2, at block 206, in some embodiments, the merchant system 114 can detect a second user input via the merchant dashboard 116. The second user input can specify one or more of a time metric, a location metric, a display metric, and a reward metric. associated with the VR advertising campaign. For example, in system 100, the merchant can use the merchant dashboard 116 to configure the VR advertising campaign to be active only during specific time windows and at specific locations. The VR advertising campaign may not be displayed on the map at other times. The rewards distributed for completing the interactive activity may be distributed in a certain way, and only during those active time windows. In some embodiments, the distribution of rewards may vary and/or be limited by daypart, intended recipient, user, location, trigger condition (e.g., what activity the user must complete to obtain the reward), etc.

FIG. 5B depicts an exemplary merchant dashboard 116 that can be used by a merchant to configure one or more time metrics for a VR campaign, in accordance with some embodiments. As shown in the figure, a merchant can interact with the text boxes, drop-down menus, toggles, and buttons on the merchant dashboard 116 to select a time metric for the campaign. In some embodiments, the time metric can include one or more of: a daypart, a campaign start date, a campaign end date, a campaign start time, a campaign end time, a reward collection start time, and a reward collection end time. A daypart can be a specific time range, e.g., 12:00 PM ET to 2:30 PM ET, during which the campaign and/or reward collection is active. In some embodiments, the merchant can specify, using the merchant dashboard 116, that rewards are to be distributed after the conclusion of the campaign if a user has previously visited a map location while the campaign was active. The merchant can set an upper limit for the total number of times users can visit a map location during the campaign, limit the campaign to a specific period of time (e.g., years, months, days, hours, and minutes), and limit the reward distribution/collection to a specific period of time. In some embodiments, using the merchant dashboard 116, the merchant can specify one or more time ranges for multiple campaigns and toggle between which campaigns are active at a given time.

In some embodiments, using the merchant dashboard 116, the merchant can select a specific daypart to entice customers to visit a store during off-peak hours. For example, a retail store that typically experiences lower customer volume on weekdays between 2 PM and 4 PM may configure a VR advertisement campaign to run between those hours, providing customers with an incentive to visit the store, earn rewards, and potentially make purchases while in the store. This can boost store earnings during off-peak hours.

FIG. 5C depicts an exemplary merchant dashboard 116 that can be used by a merchant to configure one or more location metrics for a VR campaign, in accordance with some embodiments. As shown in the figure, a merchant can interact with the text boxes, drop-down menus, toggles, and buttons on the merchant dashboard 116 to select a location metric for the campaign. In some embodiments, the location metric can include one or more of: a map location (e.g., any address or geolocation feature on a map), a merchant location (e.g., a specific map location corresponding to a real-world location of a business), a visit limit for a location, a reward limit for a location, a latitude, a longitude, and a radius for reward collection. Selecting an appropriate location metric using the merchant dashboard 116 can allow merchants to precisely map and target the appropriate users of the interactive VR app 122 during the campaign. In some embodiments, using the merchant dashboard 116, the merchant can specify one or more locations for multiple campaigns and toggle between which campaigns are displayed at a given location.

The reward location for a given advertisement campaign can be the location within a VR map that users must visit in order to collect the offered reward. In some embodiments, using the merchant dashboard 116, the merchant may specify that a user must be within a predefined proximity to the merchant's business location in order to collect a reward. The merchant can specify the proximity radius within which the user must be when their user device 120 sends a collection indication 124. For example, a merchant can specify that a given reward must be collected by a user scanning a QR code on a physical counter in a brick-and-mortar business location. The proximity radius may be as precise as one meter, enabling merchants to target specific locations within a store (e.g., a specific aisle and/or floor).

The collection indication 124 may include a confirmation that a user has scanned a quick response (QR) code at a specified location using their user device. The collection indication 124 may include the user performing some action on their user device while physically located in a specific location. For example, the user can tap and hold a collect “button” on the screen of their user device while located inside of a merchant's business location. In some embodiments, the indication 124 can occur immediately when the user is located in a specified geolocation. For example, the specified location may have a global positioning system (GPS) beacon and the user device may automatically send the collection indication to interactive VR program 108 upon being within a specified proximity of the beacon. Alternatively, the collection indication 124 may include a confirmation that a user has scanned a radio frequency identification (RFID) tag at a specified location using their user device.

In some embodiments, when setting the proximity radius using the merchant dashboard 116, a merchant has control over the generation of foot-traffic to their physical business location and thus provides a means for the merchant to encourage and generate foot traffic. Alternatively, a merchant may specify the location is a specific location within the VR map that is not necessarily near the merchant's business location. For example, a merchant may specify that a reward can be collected near a competitor's business location and then redeemed at the merchant's business location elsewhere. In some embodiments, a merchant may offer a reward that can be redeemed at their business location but collected at a location within the VR map that corresponds to a heavily trafficked area such as outside of a public transit area, a mall, or near a collection of restaurants, in non-limiting examples.

FIG. 5D depicts an exemplary merchant dashboard 116 that can be used by a merchant to configure one or more display metrics for a VR campaign, in accordance with some embodiments. As shown in the figure, a merchant can interact with the text boxes, drop-down menus, toggles, and buttons on the merchant dashboard 116 to select a display metric for the campaign. In some embodiments, the display metric can include one or more of: an icon representing the campaign, text representing the campaign, an icon representing the activity, text representing the activity, a visual code, a notification, a countdown for a time limit, a timer, and a map. The icons and displayable features may be uploaded by the merchant or pre-loaded in the VR advertisement platform. For example, if the merchant is affiliated with a local bakery, the merchant can upload the bakery's icon to the merchant system 114 and use the merchant dashboard 116 to select the bakery icon as the icon representing the campaign. The bakery's icon can then be displayed on a map at a given location (e.g., a location specified by the one or more location metrics for the VR campaign). The merchant can enter text explaining how the campaign works and what the rewards are (e.g., users will receive 10% off a bakery purchase upon scanning an in-store QR code using the interactive VR app 122). The merchant can select, from a list of pre-loaded icons, a camera or QR code icon as the icon representing the activity. As the campaign approaches its end time, the merchant can choose to display a notification, timer, and/or countdown to alert users of the remaining campaign time.

In some embodiments, the merchant can use the merchant dashboard 116 to upload any images and/or materials to be displayed as part of the VR advertising campaign. For example, the merchant can provide, using a user input such as the second user input, instructions to the merchant dashboard 116 specifying an image to be uploaded. The image can be used to represent the campaign and/or a reward associated with the campaign.

In some embodiments, the merchant can use the merchant dashboard 116 to create a QR code that can be associated with a coupon, discount, or other reward. In some embodiments, the merchant can use the merchant dashboard 116 to create a collectible virtual item that can be obtained by users, traded between users, and/or stored in a digital reward wallet of a user.

FIG. 5E depicts an exemplary interactive dashboard that can be used by a merchant to configure one or more reward metrics for a virtual-reality campaign, in accordance with some embodiments. As shown in the figure, a merchant can interact with the text boxes, drop-down menus, toggles, and buttons on the merchant dashboard 116 to select a reward metric for the campaign. In some embodiments, the reward metric can include one or more of: a reward type, a reward trigger (e.g., what needs to happen for a reward to be given to a user), a follow-up reward, a reward price, a reward quantity, and a conversion rate between rewards and currency. Using the merchant dashboard 116, merchants can assign different mechanisms for reward triggers and vary them by campaign and reward.

In some embodiments, when deploying an advertisement campaign, a merchant may be prompted to select a reward type that can be collected. The reward type may be a coupon for a specific merchant or a reward of one or more digital units corresponding to real-world currency. The merchant may also be prompted to specify reward data such as a title for the reward, reward type, the reward icon that will be displayed to the user, information regarding how the user can collect the reward, reward terms and conditions etc. In some embodiments, the reward data will be categorized into a title and sub-title that will be displayed when the reward is selected by a user. For example, when the user selects a given reward, the interactive VR app 122 may display a title including general reward information such as the merchant name, type and amount of reward, and a sub-title including information such as the terms and conditions of the reward, the expiration date of the reward, a coupon code, etc. According to some embodiments, when generating an advertisement campaign, the merchant may view an advertisement preview on their merchant dashboard 116 before launching the campaign.

Referring back to FIG. 2, at block 208, in some embodiments, the merchant system 114 transmit campaign instructions for rendering a VR asset associated with the campaign. The VR asset can include a visualization, such as images, graphics, text, and/or videos. The VR asset can include audio effects, haptic effects, and other VR effects. The campaign instructions may be transmitted to the administrator server 102 and/or user devices 120 via the network 130. The campaign instructions can be generated based on the first user input detected at block 204 and the second user input detected at block 206.

In some embodiments, the rendered VR asset may be a VR visualization may be associated with the interactive activity specified by the first user input. For example, the rendered VR visualization can include at least a portion of one or more of: an advertisement, a map, a user icon, a merchant icon, a virtual-reality game, a poll, a quiz, a virtual-reality scavenger hunt, an interactive character, a digital wallet, a currency icon, a reward icon, a collectible icon, and a coupon. The rendered VR visualization may be displayed on the interactive VR app 122 at a time and location specified by the second user input and containing icons, text, and/or rewards specified by the second user input.

In some embodiments, the merchant system 114 can detect a third user input via the merchant dashboard 116 in addition to the second user input as described above. The third user input can specify a target demographic of the campaign. In such embodiments, at block 208, the campaign instructions can be generated based on the first user input, the second user input, and the third user input. The campaign instructions may be transmitted to user devices 120 associated with the target demographic specified by the third user input. For example, if the target demographic includes college-educated women between the ages of 25-65, the campaign instructions may be transmitted to user devices 120 associated with such college-educated women of the target demographic. In some embodiments, target marketing lists containing target demographics for different campaigns can be preloaded onto the VR advertisement platform such that only certain users receive certain rewards and/or can access certain campaigns.

Referring back to FIG. 2, at block 210, in some embodiments, the merchant system 114 can receive user engagement data associated with the campaign. The user engagement data may be obtained based on user engagement with the rendered VR visualization of block 208. In some embodiments, monitoring campaign engagement can include monitoring engagement with specific parts of the campaign, such as the rendered VR visualization. For example, in system 100, as a user participates in campaign-related interactive activities within the interactive VR app 122, the user device 120 may track how the user engages with the campaign. The user engagement data may be transmitted from the user devices 120 via the network 130. In some embodiments, the user engagement data can include one or more of: user time data, user location data, user purchase data, and user reward data. In some embodiments, the user time data can include one or more of: time spent at a map location, frequency of visits to the map location, time spent walking between map locations, and time spent engaging with the interactive activity associated with the campaign. In some embodiments, the user location data can include one or more of: number of visits to a map location, number of visits to new locations, and ratio of new visits to returning visits. In some embodiments, the user purchase data can include one or more of: number of purchases at a map location, total profit from the purchases, and average cost of the purchases. In some embodiments, the user reward data can include one or more of: number of rewards awarded, number of the rewards left over, type of the rewards awarded, and value of the rewards awarded.

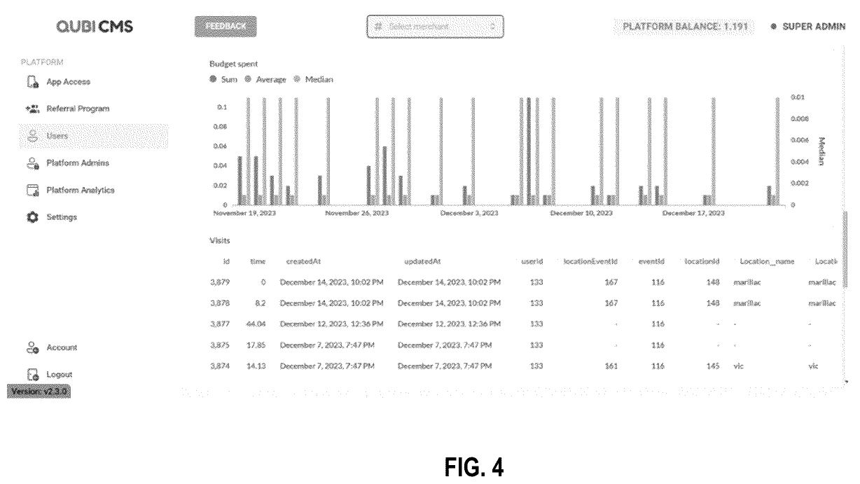

At block 212, in some embodiments, the merchant system 114 can generate, using the merchant dashboard 116, analytics visualizations associated with the campaign. The analytics visualizations can be generated based on the user engagement data received at block 210. In some embodiments, the analytics visualizations can include one or more of: a map, a graph, a table, a list, and a statistic. The analytics visualizations can represent any aspect of the user engagement data (e.g., user time data, user location data, user purchase data, and user reward data) in visual form. For example, FIG. 4 depicts an exemplary merchant dashboard 116 configured to generate analytics visualizations associated with the VR campaign based on user engagement data, in accordance with some embodiments. As shown in the figure, the merchant dashboard 116 can display graphs analyzing how much money the merchant spent in providing rewards to customers. The graphs can contain summary statistics over time, e.g., how much money the merchant spends on average, and how much was spent on a given day. Furthermore, the merchant dashboard 116 can display a list of users who visited a given location, along with the time of visit, the exact reward collected, a user ID associated with the user, etc.

Upon the completion of method 200, in some embodiments, the merchant can choose to repeat one or more blocks of method 200 to adjust the campaign based on the user engagement data received at block 210 and/or the analytics visualizations generated at block 212. The merchant can use the merchant dashboard 116 to update one or more of the time metric, the location metric, the display metric, and the reward metric based on the user engagement data. This iteration process allows the merchant to refine the campaign settings and engage with the target demographic of users. For example, in some embodiments, the merchant may receive user engagement data indicating that only 10% of users are making in-store purchases when visiting a real-world location linked to the campaign. To increase the conversion of users to purchasing customers, the merchant may change a reward metric using the merchant dashboard 116 to provide users with a % off coupon (e.g., 50% off).

Upon the completion of method 200, in some embodiments, a merchant can re-launch a prior campaign using the merchant dashboard 116. To re-launch a prior campaign, a merchant can, in some embodiments, select a new period for the campaign or specify a new budget and payment scheme. Beneficially, by enabling a merchant to design, update, and launch campaigns themselves, the interactive VR system enables merchants to autonomously control their advertisement campaigns without relying on a third party to build campaigns for them. In some embodiments, a merchant can set a campaign to reoccur on a regular basis, e.g., every Friday from 3-5 PM.

Upon the completion of method 200, in some embodiments, the merchant can control what analytics visualization, if any, is displayed by the merchant dashboard 116. In some embodiments, the merchant system 114 can detect a fourth user input via the merchant dashboard 116 in addition to the other user inputs as described above. The fourth user input can be associated with selecting an analytics visualization and displaying, on the computing device accessible to the merchant, the selected analytics visualization based on the fourth user input. For example, by default, the merchant dashboard 116 may display analytics visualizations for the most recent time range of the campaign (e.g., the past 5 days). However, the merchant can choose to display analytics visualizations from an earlier time range, or to disable the display of analytics visualizations entirely. In some embodiments, the merchant can toggle between the display of analytics visualizations and the adjustment of campaign settings via a click, press, type, or other interaction with the merchant dashboard 116. For example, to display an analytics visualization, the merchant can select an analytics button on a sidebar of the merchant dashboard 116, and to display a campaign settings adjustment menu, the merchant can instead select a settings button on the sidebar.

In some embodiments, the display of the analytics visualizations via the merchant dashboard 116 may be restricted based on the merchant's credentials, as managed by the credential module 117. To perform the credential-based restriction, in some embodiments, the merchant system 114 can detect a fifth user input via the merchant dashboard 116 in addition to the other user inputs as described above. The fifth user input can be associated with inputting a user access credential of the merchant. For example, a regular merchant may be an administrator who manages campaigns for one brand and/or business. The merchant is unable to access campaign settings and/or analytics for other brands and/or businesses. A super-administrator may be a special type of merchant that supervises multiple brands and/or businesses and thus is permitted access to the campaign settings and/or analytics. Using the merchant dashboard 116, a super-administrator may input a user access credential (e.g., a password) verifying the identity of the super-administrator. The merchant system 114 can compare the user access credential to one or more stored credentials in the the credential module 117 (e.g., verifying the super-administrator's access level) to determine what permissions the super-administrator should receive. If the access level exceeds a threshold access level (e.g., the super-administrator access level), merchant system 114 can display, on the merchant dashboard 116, one or more additional analytics visualizations that may not be displayed to users without sufficient credentials. The additional analytics visualizations may be associated with a plurality of interactive virtual-reality campaigns (e.g., campaigns for multiple brands/businesses). The additional analytics visualizations can include one or more of: a budget breakdown for each campaign of the plurality of interactive virtual-reality campaigns, identifying information associated with the one or more user devices, a list of transactions associated with each campaign of the plurality of interactive virtual-reality campaigns, summary statistics for the plurality of interactive virtual-reality campaigns, and a ranking of the plurality of interactive virtual-reality campaigns.

According to some embodiments, a super-administrator can manage an organization of merchants of varying access levels. The super-administrator can organize joint events and/or campaigns that multiple merchants can participate in. For example, the super-administrator may host a scavenger hunt on a particular day and indicate that certain businesses within a defined region can elect to participate in the scavenger hunt. In some embodiments, existing activities can be displayed on a merchant dashboard, such as merchant dashboard 116, and include participation information. Such participation information can include parameters for users to collect a virtual reward in the activity, the cost to a merchant to participate in the activity and a projected return on participation.

According to some embodiments, a merchant may be charged one or more fees to access one or more functionalities of the merchant dashboard 116. For example, a merchant may be charged an advertising fee to create a campaign, and creating additional campaigns may cost additional fees. In some embodiments, a merchant may be charged a fee upon the creation of a virtual reward and/or redemption of a virtual reward by a user. For example, the merchant may pay a fee corresponding to the number of users who have redeemed a virtual reward.

### Interactive VR Program and Advertisement Module

According to some embodiments, the merchant dashboard 116 can be used to provide inputs that shape how the interactive VR program 108 generates activities and rewards for users. In some embodiments, the VR system module 111 can receive advertisement information from advertisement module 110. The advertisement information may include a merchant campaign icon, a geolocation with coordinates for the icon to be displayed within an interactive map, and reward information such as instructions for how a user can collect the reward, reward monetary value, reward type, expiration date, etc. In some embodiments, advertisement module 110 can enable merchants to manage campaigns and manage the merchant's account. Managing a campaign can include, for example, ending a campaign early, extending a campaign, increasing a campaign budget, decreasing a campaign budget, etc. Managing a merchant account can include updating payment information, updating merchant contact information, updating merchant geographic location, etc. In some embodiments, advertisement module 110 may report campaign metrics such as remaining campaign period, remaining campaign budget, remaining rewards available to users, value of rewards that have been collected, etc. By providing campaign metrics to merchants, the interactive VR system enables merchants to clearly correlate the return on investment of a given campaign.

In some embodiments, interactive VR program 108 can publish a merchant-specific reward icon to be displayed in an interactive map displayed on one or more user devices by an interactive VR app such as interactive VR app 122. In some embodiments, the merchant-specific reward icon may appear as a general reward icon until a given user approaches the geolocation of the merchant-specific reward to transform the icon from a general reward icon to a merchant-specific icon.

In some embodiments, interactive VR program 108 can receive a collection indication from a user. Interactive VR program 108 can receive a collection indication from a user device such as user device 120. The collection indication may include a confirmation that a user has scanned a quick response (QR) code at a specified location using their user device. The collection indication may include the user performing some action on their user device while physically located in a specific location. For example, the user can tap and hold a collect “button” on the screen of their user device while located inside of a merchant's business location. In some embodiments, the indication can occur immediately when the user is located in a specified geolocation. For example, the specified location may have a global positioning system (GPS) beacon and the user device may automatically send the collection indication to interactive VR program 108 upon being within a specified proximity of the beacon. Alternatively, the collection indication may include a confirmation that a user has scanned a radio frequency identification (RFID) tag at a specified location using their user device.

In some embodiments, interactive VR program 108 can verify whether the collection indication received is the proper method and occurred within a specified proximity to a geolocation. The proper method for collection can be determined by the respective merchant who launched a given campaign. In some embodiments, the merchant may specify the proximity radius within which the user must be when their user device sends the collection indication. For example, a merchant can specify that a given reward must be collected by a user scanning a QR code on a physical counter in a brick-and-mortar business location. If interactive VR program 108 determines that either the indication is not the proper method or that a collection indication was not sent from the user device while the user device was within the specified proximity, interactive VR program 108 may deny the collection. If interactive VR program 108 determines that both the indication is the proper method and was sent from the user device within the specified proximity, interactive VR program 108 can approve the collection.

In some embodiments, interactive VR program 108 can distribute reward data to the user device. According to some embodiments, the reward data can include information corresponding to a digital unit corresponding to real-world currency. The reward data may include information corresponding to a coupon that can be used at a real-world merchant corresponding to the merchant-specific reward being redeemed.

In some embodiments, interactive VR program 108 can cause a reward notification to be displayed on a user interface of a user's device. The reward notification can be a congratulations screen. The congratulations screen may include information relating to the value of the reward being collected. The congratulations screen may include an option for the user to click an area of the screen to view all reward options available. In some embodiments, the reward notification will prompt the user to select to either: (1) redeem the reward at the real-world merchant corresponding to the merchant-specific reward being collected, or (2) redeem the reward to the user's digital wallet. The reward notification may indicate that if the user redeems the reward at the real-world merchant, the user will receive 100% of the value of the reward, but if the user redeems the reward to the user's digital wallet, the user will receive some lesser percentage of the value of the reward. For example, the reward notification may indicate an option for the user to redeem a reward of $5 at the merchant or redeem a reward of $1.75 to the user's digital wallet. Where the reward is a coupon for a merchant, for example, the reward notification may indicate an option for the user to redeem a coupon reward of $5 usable at that merchant or redeem a coupon reward of $1.75 usable at any participating merchant within the system.

In some embodiments, where the reward data includes information corresponding to a digital unit corresponding to real-world currency, advertisement module 110 can cause an account balance of the merchant account corresponding to the reward being redeemed to decrease according to the digital unit value. Advertisement module 110 may cause a campaign balance of a specific advertisement campaign to decrease according to the digital unit value being redeemed. Reward module 112 may cause a digital wallet balance of the user that is redeeming the reward to increase according to the digital unit value.

In some embodiments, where the reward data includes information corresponding to a coupon that can be used at a real-world merchant corresponding to the merchant-specific reward being redeemed, advertisement module 110 may cause an account balance of the merchant account corresponding to the reward being redeemed to decrease according to the coupon value. Advertisement module 110 may cause a campaign balance of a specific advertisement campaign to decrease according to the coupon value being redeemed. In some embodiments, reward module 112 can cause a digital wallet of the user that is redeeming the reward to add the coupon to the digital wallet.

According to some embodiments, advertisement module 110, may award an additional reward after a user redeems a merchant-specific reward. Advertisement module 110 may award an additional reward if the user immediately makes a purchase at the merchant corresponding to the reward that was redeemed. For example, a user may redeem a merchant-specific reward that includes a digital unit worth $5 real world currency, and the user may receive a notification that if they immediately make a purchase at the merchant using the $5 reward, they will receive a future reward that can be redeemed at the same merchant. The future reward may be redeemable at one any participating merchants within the system. For example, upon making a purchase using the $5 reward, the user may receive a 10% off coupon redeemable at the same merchant or at any participating merchant.

### Interactive VR System Module

In some embodiments, a user can register to participate in an interactive VR system. Registration can include the user providing and verifying contact information, choosing a username, selecting an avatar image, etc. To register, a user may be required to complete information for a user profile. Information for a user profile can include, but is not limited to, the user's name and address, and demographic information. The information in the user profile may be used by the interactive VR system to determine which users are target customers of a given campaign (e.g., users under age 65). A unique numerical identifier may be assigned to each new user who registers to participate in system 100. In some embodiments, when registering to participate in interactive VR system 100, a user may be directed to enroll via other network systems such as Facebook, Google, Apple ID, Android, etc.

In some embodiments, a user can link a payment method. A user may link a payment method via a component that establishes connection to a mobile payment network, such as connectivity to mobile payment network block 318. A user may provide a credit card for a payment method. When providing a credit card, a user may be prompted to provide a card number, cardholder name, expiration date, CVV pin, and designate a card nickname. A user may link a bank account to be the user's payment method. When linking a bank account, a user may be prompted to provide identifying information for a banking institution, a bank account number and identifying information for the account holder, and a routing number for the account.

In some embodiments, the user may collect and redeem virtual rewards within an interactive VR system provided via interactive VR app 122 of system 100. In some embodiments, upon redeeming a reward, a user will be prompted to elect to redeem the reward cither at a merchant associated with the particular reward, or to the user's digital wallet within interactive VR system. When redeeming a reward at a merchant, the reward may have stipulations set by the merchant. Such stipulations can be, for example, a specified term upon which the reward is valid, a monetary value of the reward, specified purchases that the reward can be used on, etc. When redeeming a reward in the user's digital wallet, the reward may have a lesser valuation in comparison to redeeming the reward for the merchant. For example, a virtual reward corresponding to a particular merchant may have a stipulated reward value that can be redeemed for 100% of the reward value if redeemed at the merchant, but may only be redeemed at some smaller percentage, such as 25% of the reward value, if redeemed into the user's digital wallet. By providing a variable reward value scheme with the highest value being at the time of collection at the merchant location, the interactive VR system encourages users to spend collected rewards immediately rather than storing a reward in the user's digital wallet. Thus, interactive VR system provides a platform for merchants to encourage customers to spend upon visiting their business location.

In some embodiments, the user may access the interactive VR app 122 via a user device 120, which can be any computing device. Within the interactive VR app 122, a map-based user interface may be displayed. The map-based user interface may include a display window that can be used to display an interactive map and various other aspects of the interactive VR system such as a user avatar, merchant-specific reward icons, general reward icons, and user identifying information. In some embodiments, the map-based user interface can include a menu for accessing game settings or for navigating to an alternate user interface. The reward icons can be any number of shapes, such as circular, triangular, rectangular, octagonal, and square, etc. The color of a particular avatar, reward icon, or interactive map, respectively, can be one of any number of colors.

In some embodiments, the display window of the map-based user interface can also include billboard advertisement icons. Billboard advertisement icons can be located at random locations within the VR map or at specific locations selected by a merchant or a system administrator. Billboard advertisement icons can correspond to a general reward that may be redeemed at any participating merchant. For example, the system administrator may offer a general reward that can be collected by a user and then redeemed at any participating merchant. In a non-limiting example, the system administrator may offer a general reward outside of a mall that can be redeemed at a participating merchant within the mall. Alternatively, billboard advertisement icons can correspond to a merchant-specific reward that may be redeemed at any location owned by that merchant. For example, a merchant may offer a merchant-specific billboard reward advertising a new product that can be collected and then redeemed at any one of multiple business locations owned by the merchant. In some embodiments, a billboard advertisement may not have a collectable reward and may solely display a billboard advertisement icon for a specific merchant. Billboard advertisement icons may, in some embodiments, be identified by an icon that is a different shape and/or color than reward icons displayed in the VR map.

In further embodiments, the billboard advertisement icons can correspond to intermittent rewards awarded pursuant to intermittent reinforcement principles. In one or more embodiments, the geolocation associated with the intermittent reward can be a location specified by the system administrator and/or can be a location selected and sponsored by a merchant. The intermittent reward can be awarded by the system administrator and/or by a given merchant. Intermittent reinforcement principles can include variable ratio reinforcement, variable amounts, a ratio schedule, and/or an interval schedule. Variable ratio reinforcement can include awarding an intermittent reward randomly and/or intermittently based on geolocation, with the goal being to create behavioral reinforcement and encourage users to repeatedly visit a particular location. Similarly, awarding a reward that can have a variable amount will prevent users from predicting the amount they may collect if an intermittent reward is awarded and thereby encourage users to engage in behavior they believe may lead to a reward in case they might receive a large reward. The intermittent reward can be awarded pursuant to a ratio schedule wherein a specified number of responses are required before the reward will be awarded. The specified number may be a fixed number or it may vary. In some embodiments, the intermittent reward can be awarded pursuant to an interval schedule. That is, the intermittent reward can be awarded after a certain period of time after the last award. For example, an intermittent reward may be awarded every two months. This period of time may be fixed, or it may be variable. Beneficially, by preventing users from predicting the conditions which will lead to an intermittent reward being awarded or the amount of a potential intermittent reward, the system can encourage users to continue exploring to increase their chances of being awarded an intermittent reward.

In some embodiments, the display window of the map-based user interface can include two versions of reward icons: a merchant-specific reward icon and a general reward icon. A general reward icon may transform into a merchant-specific reward icon as a user enters a specified proximity around a geolocation associated with the merchant-specific reward icon, thus enabling the user to see what reward a given merchant is offering only by approaching the merchant location. For example, a user may initially see only general icons within the display window, but upon the user physically approaching the real world geolocations associated with the some of the general reward icons and the avatar moving within the interactive map contemporaneously with the user's movement in the real world, the general reward icons will transform into merchant-specific reward icons for a specific merchant that is offering a reward at that particular geolocation.

In some embodiments, a user can select a merchant-specific reward icon displayed on the map-based user interface to view reward information for that specific icon. A user can select a merchant-specific reward icon, for example, by tapping on the screen of their device, swiping on the screen of their device, using an auxiliary device such as a mouse with a pointer, etc. Reward information for a specific merchant-specific reward icon can include, for example, instructions for how a user can collect the reward, reward monetary value, reward type, expiration date, etc.

### Reward Wallet Module

In some embodiments, reward wallet module 112 can manage rewards users earn or collect and redeem in interactive VR app 122 using a digital wallet. The digital wallet can store merchant-specific rewards collected by users in the interactive VR map. In some embodiments, the digital wallet can store coupon rewards from merchant-specific rewards collected and redeemed by a user in a digital coupon wallet. For example, the digital coupon wallet can store one or more reward codes and/or QR codes that corresponds to a respective merchant-specific reward that was collected and redeemed.

In some embodiments, the merchant can choose to distribute virtual rewards only to users who are within a specific geographical area specified by the merchant. For example, using the merchant dashboard 116, a merchant can configure campaign settings such that users are required to visit a brick-and-mortar store location in order to execute a virtual reward within the interactive VR app 122. This can enable a merchant to distribute virtual awards only to potential customers within the brick-and-mortar store. Alternatively, the merchant may distribute virtual rewards to a specific group of users irrespective of the users' geographical location. For example, the merchant may choose to distribute virtual rewards to users who have previously visited the brick-and-mortar store but are not currently in the vicinity of the store, or to distribute virtual rewards to users who participated in a virtual event associated with the store. In some embodiments, rewards may only be distributed to a user if the user visits a location a certain number of times, if the user visits a certain number of locations, and/or if a user collects a certain number of virtual items (e.g., as part of a virtual scavenger hunt within the interactive VR app 122).

In some embodiments, the merchant can use the merchant dashboard 116 to view analytics about the distribution of virtual rewards to users within the interactive VR app 122. For marketing attribution purposes, the merchant may wish to track and analyze which rewards are most effective at engaging with users. For example, the merchant dashboard 116 may be used to display analytics pertaining to the number and demographic of users who engage with a given advertising campaign to earn rewards, which types of rewards are most popular with users, which users are most likely to buy products in a brick-and-mortar store after visiting the store location to execute a virtual reward, etc.

According to some embodiments, the digital wallet can include a digital unit wallet to store digital units from merchant-specific rewards that were collected and redeemed by a user via interactive VR app 122. In some embodiments, digital units stored in the digital unit wallet are not usable until the digital units have been converted. Digital units can be converted into, for example, real-world currency, mobile minutes for a specified phone carrier, a digital coupon or offer for a specified merchant, etc. For example, a user may earn digital units corresponding to real-world currency, but the user cannot use the real-world currency until the user has converted the digital units into real-world currency. Beneficially, by awarding rewards subject to a vesting period, users will be motivated to continue using the application to prevent leaving earned rewards unused. Accordingly, the vesting period aids user retention and participation in the system.

In some embodiments, conversion of digital units is subject to the digital units completing a specified vesting schedule. For example, digital units may vest incrementally over a specified period of time wherein one third of the digital units vest at a first time, another third of the digital units vest at a second time, and a third and final third of the units vest at a third time. Upon completing a vesting schedule a user may be prompted to convert the units. Alternatively, digital units may convert automatically upon completion of a corresponding vesting schedule.

In some embodiments, the reward type can be a digital unit corresponding to real-world currency. If the user redeems the digital unit, the user's digital wallet may be increased by the specified value of the digital unit simultaneously with a deduction from a merchant account corresponding to the virtual reward being redeemed. The reward type may be a coupon that can be used at a real-world merchant corresponding to the virtual reward being redeemed. In some embodiments, the coupon is redeemable only at that merchant. Where the reward is a coupon, the coupon may include a reward code. Upon redeeming a coupon, the user may receive a reward code, a generation date of the reward code, and an expiration date for the reward code. For example, the user may receive a reward code that gives the user 30% off specified purchases during a specified period. Alternatively, a coupon may include a QR code for a merchant to scan.

According to some embodiments, the user can elect to store a coupon to their digital wallet to be used at other participating merchants within an interactive VR system. In some embodiments, if a user elects to store a value of the coupon, the value of the coupon will be reduced compared to the value of the coupon if the user elected to use it at the merchant corresponding to the virtual reward being redeemed. In some embodiments, the reward type may be a reward limited to a specified period. Alternatively, the reward may vary in value over time. For example, if used within a first period, the reward may have a 100% value, if used within a second period after the first period, the reward may have an 80% value, and so on.

In some embodiments, reward wallet module 112 may cause a user to receive a bonus reward. The bonus reward may be awarded by a merchant pursuant to an advertisement campaign. For example, a merchant may specify that some users who collect a reward by performing the appropriate collection procedure at the specified location will receive a bonus reward in addition to the offered reward. In some embodiments, the bonus reward may be awarded by the system administrator via reward wallet module 112. In non-limiting examples, reward wallet module 112 may award a bonus reward after a user redeems a merchant-specific reward or upon satisfaction of a trigger condition. The trigger condition may occur when the user accumulates digital units equal to a specified value in their user wallet. For example, reward wallet 112 may award a bonus reward upon a user accumulating digital units equal to $100 in the user's digital wallet.

In some embodiments, the bonus reward may be awarded randomly or heuristically. In accordance with Skinnerian box principles, by receiving bonus rewards at unpredictable intervals, users may be motivated to continue actions they believe will result in a bonus reward being awarded. For example, when a user receives a bonus reward after redeeming a reward at a merchant, the user may be motivated to collect and redeem more rewards at that merchant and other participating merchants in order to increase the chances of the user receiving an additional bonus reward. Beneficially, this will increase the user's participation within the system and motivate users to continue collecting rewards, thereby increasing foot traffic to merchant locations. Additionally, users may perceive bonus rewards as a “windfall” and thus be more motivated to spend them immediately. In some embodiments, when a bonus reward is awarded to a user, the reward can include a share link that enables the user to share that they have received a bonus reward to one or more of the user's social media platforms. Beneficially, a user sharing such bonus reward may motivate other users to join the system and act as an advertising method for the system to gain additional users.

In some embodiments, a user may receive a bonus zone reward after visiting a specified number of locations within a predefined area. The bonus zone reward may be offered and distributed by the system administrator. Alternatively, the bonus zone reward may be offered, in non-limiting examples, by a single merchant, a group of merchants, an entity that owns multiple merchant locations, or an entity that owns area leased by multiple merchants. For example, after a user collects a specific number of rewards in a mall, the user may receive a bonus zone reward from the mall owner. Alternatively, the user may receive a bonus zone reward from a franchise owner after visiting multiple locations of the franchise. In some embodiments, the bonus zone reward may be awarded pursuant to a scavenger hunt-type game. For example, the user may collect rewards at specified locations and with each reward collected also earn a game piece; upon collecting every game piece, the user may receive the bonus zone reward.

In one or more embodiments, the bonus and/or bonus zone rewards may be awarded according to intermittent reinforcement principles, as discussed above with respect to intermittent rewards.

In some embodiments, reward wallet module 112 can cause the user to receive a bonus and/or bonus zone reward if the user collects a plurality of virtual items. For example, if a user collects a full set of collectible cards and adds them to the user reward wallet, the reward wallet module 112 may award the user an additional reward, such as a trophy, achievement, coupon, currency, or any other reward described herein.

In some embodiments, a merchant can use the merchant dashboard 116 to specify which rewards are distributed to which users. For example, users may be targeted based on user demographics and past purchasing behavior such that different users may receive different rewards. The merchant can view the past purchasing behavior of a user to determine if the user is a good candidate for the reward, then use the merchant dashboard 116 to select the user to receive the reward. Rewards may be provided to users based on past purchasing behavior that fits the desired needs of the merchant.

In some embodiments, reward wallet module 112 can display a user reward wallet on a user device. The reward wallet may include a summary view of how many digital units a user has earned. The summary view may include a number of digital units collected by a user to date, a vesting schedule for each digital unit or a set of digital units, the total number of digital units available for conversion, the number of vested digital units, etc. In some embodiments, the summary view can include an advertisement banner containing an offer for a specific merchant. The advertisement banner may include an offer for a user to redeem a specified percentage or number of currently un-vested digital units for a specified reward. For example, the advertisement banner may offer to provide a 10% off coupon at the merchant in return for a specified number or percentage of the user's un-vested digital units. Alternatively, the advertisement banner may provide an offer in exchange for a specified number or percentage of the user's vested digital units.

In some embodiments, reward wallet module 112 can receive a conversion request from a user to convert digital units in the user's reward wallet. The conversion request may include a request to convert selected digital units into real-world currency. Alternatively, the conversion request may include a request to convert digital units in the user's reward wallet into mobile minutes for a cellular data plan. In some embodiments, reward wallet module 112 may receive the conversion request from interactive VR app 122 on user device 120.

According to some embodiments, upon receiving a conversion request to convert digital units, reward wallet module 112 can provide a bonus reward notification to the user. The bonus reward notification may provide information that the user can receive a bonus number of digital units. In some embodiments, the bonus reward notification will indicate the user can only receive a bonus number of digital units if the user opts to cancel the request to convert the selected digital units. The bonus reward notification may not indicate how many bonus digital units are available unless the user opts to cancel the request to convert the selected digital units.

In some embodiments, reward wallet module 112 can verify whether selected digital units in a user's conversion request are eligible to convert. Reward wallet module 112 can perform such verification using data stored in VR application database 106 for the specified user. Reward wallet module 112 may determine that selected digital units are not eligible to convert and may send the user an error message. The error message may provide information indicating that the user's request failed and display the time period remaining until the digital units are available to vest. Alternatively, reward wallet module 112 may determine that selected digital units are eligible to convert and may send the user a confirmation message. The confirmation message may provide information indicating that the user's request was approved and confirmation that the selected digital units were converted.

In some embodiments, reward wallet module 112 can convert selected digital units to real-world currency. Alternatively, reward wallet module 112 may convert selected digital units to mobile minutes. Upon converting selected digital units in accordance with a user's conversion request, reward wallet module 112 can provide an updated summary view screen indicating that the corresponding decrease in vested digital units in the user's reward wallet. Upon converting digital units into real-world currency, reward wallet module 112 may immediately transfer the real-world currency to a linked bank account of the user. In some embodiments, upon converting digital units into real-world currency, reward wallet module 112 can immediately transfer the real-world currency to a digital currency wallet displayed on another screen in interactive VR app 122.

According to some embodiments, interactive VR program 108 can include a digital currency wallet for a specific user. Interactive VR program 108 can interface with online banking, internet-cloud-based financial systems, or other mobile-based payment systems thereby enabling interactive VR program 108 to perform specified operations with respect to digital funds corresponding to a user using interactive VR app 122. Specified operations can include transferring funds, and/or spending funds. In some embodiments, interactive VR program 108 can enable a user to transfer digital funds to a linked bank account corresponding to the user. Alternatively, interactive VR program 108 may enable a user to transfer digital funds to other users within system 100 upon a command by the user to transfer a specified amount to a specified user.

Interactive VR app 122 can, in some embodiments, enable a user to spend digital funds stored in the digital currency wallet at a participating merchant within the system 100. In some embodiments, the wallet may be integrated with one or more other financial accounts of the user. Interactive VR app 122 may enable a user to spend funds at a merchant using a QR code that the merchant can scan to receive payment. Interactive VR app 122 may enable a user to receive and/or spend funds via peer-to-peer payment. Interactive VR app 122 may enable a user to receive and/or spend funds with minimal and/or no interchange costs.

In some embodiments, interactive VR app 122 may enable a user to spend funds at a merchant using a near-field communication (NFC) or Bluetooth communications between user device 120 and a co-acting NFC device, beacon, or Bluetooth computer system of the merchant.

### Education System Sub-Module

According to some embodiments, reward wallet module 112 includes a sub-module for implementing an educational award system within an interactive VR system. Alternatively, the educational award system sub-module may be a standalone module within the interactive VR system that is not a sub-module of the reward wallet module 112. The digital unit wallet of reward wallet module 112 can store digital units corresponding to real-world currency earned by a user via the educational award system. Digital units earned via the educational award system can be subject to similar vesting schedule requirements as discussed above. For example, the educational award system can include questions targeted for a specific grade in school and the rewards earned by a student may vest upon the close of the semester or upon graduation to the next grade. Alternatively, rewards earned may vest pursuant to a similar time-based vesting schedule. According to some embodiments, students can expedite the vesting process by completing extra credit assignments or by performing above a set level on tests. In a non-limiting example, if a student earns a 100% on a given assignment, the vesting schedule of the digital units earned by completing that assignment may vest at half the rate they would have vested otherwise.

In some embodiments, the educational award system can enable educators to create quizzes for students and offer monetary rewards based on student quiz performance. In some embodiments, educators can include a lock feature on a quiz. For example, educators can lock a quiz such that it is only accessible during a specific period or for a specified duration after opening the quiz. In some embodiments, educators can lock additional attempts to answer a given question after a specified number of attempts. For example, the educator may create a test question where the students can attempt to answer the question twice, and offer a reduced reward if answered correctly on the second attempt.

The educational award system can also enable educators to track and reward attendance by enabling students to verify attendance using a check-in feature. To verify attendance, a student may scan a QR code or RFID code at a specified location using the student's user device. For example, each classroom in a school may have a QR code or RFID code located at the entrance to the classroom or on the surface of each desk that students can scan with their user device. Alternatively, the educational award system may have access to a database with stored information that identifies specific class locations with a specific geolocation. The specific class locations may be rooms within a school or assigned remote locations. For example, when a school is conducting remote class sessions, students may be prompted to provide location information for a designated remote learning location.

The educational award system can include an interactive app displayed to students on their user device. In some embodiments, students may be prompted to verify their identity upon opening the interactive app on their user device. For example, students may be prompted to provide a unique student password or provide biometrics such as a fingerprint or self-photograph before any quizzes or check-in features are accessible.

In some embodiments, an educational quiz user interface may be displayed within an interactive VR application implemented by an interactive VR program, such as VR app 122 implemented by interactive VR program 108 of system 100. The educational quiz user interface can include a display window that can display one or more available quizzes which can be attempted by selecting a selection icon. The type of quiz available can include more than just subject categories. For example, the available quizzes can be categorized by date, educator, class title, term of school, etc. In some embodiments, the display window can display one or more of a quiz subject, quiz question, quiz answers, and an advertisement. In some embodiments, the display window can be used to provide a reward notification to a student after the student provides a correct answer to a quiz.

Students can earn rewards with digital units corresponding to real-world currency by correctly answering quiz questions. In some embodiments, students can only earn rewards by selecting the correct answer in a quiz. Alternatively, students may earn partial credit and some portion of a reward even if they do not select the correct answer in a quiz. In some embodiments, in order to earn partial credit, a student may perform an additional task such as watching a custom teaching video and/or performing some extra task set by the educator. Digital units earned by answering quiz questions may automatically be stored in the user's digital unit wallet.

According to some embodiments, educators can create and upload teaching videos tailored to specific test questions that are only playable after a student attempts to answer a question. The student may be presented with an option to watch the education video after submitting an answer to a quiz question, and the video may play upon the student's selection of the option to play the video. For example, an educator can create a teaching video that explains why a given answer is correct and the alternative answers are incorrect.

Students can also earn rewards of digital units corresponding to real-world currency by verifying attendance for class sessions. According to some embodiments, students can verify classroom attendance by scanning an RFID or QR code at a classroom location. In some embodiments, once the student's user device is located within a specified proximity of a classroom, their user device may automatically send an attendance verification signal to reward wallet module 112 of interactive VR program 108. Alternatively, the student may manually send a check-in notification using a graphical user interface on their user device to verify attendance.

In some embodiments, rewards for attendance can be offered to users via interactive VR app 122 provided to a user on a user device 120 within system 100. For example, the interactive VR app 122 may have a merchant version and an education version, wherein the education version includes icons displayed at classroom locations that students can interact with using their user device 120. For example, interactive VR app 122 may include an education version of the a map-based user interface that includes class-specific icons in the geolocation of a given class. The class-specific icons may identify a teacher, a subject, a specific classroom, etc. If a student were to have a geography class at a certain location, for example, the location may be identified by an icon with a globe that the student can select on their user device to check-in for a class period.

In some embodiments, interactive VR app 122 may include quiz icons displayed on the education version of the interactive VR map which are selectable to change the display to a quiz. Interactive VR app 122 may display the class-specific icon on the interactive VR map for the student to verify attendance and thereafter display a quiz icon that the student can select which will cause interactive VR app 122 to display a new display window with a quiz. For example, if a certain quiz is available to students in the first ten minutes of a geography class, interactive VR app 122 may display an interactive map with a geography class-specific icon to verify attendance and thereafter display a quiz icon that prompts the student to start the geography quiz.

### Advertiser Quiz Sub-Module

According to some embodiments, reward wallet module 112 includes a sub-module for implementing an advertiser quiz platform within the interactive VR system. Alternatively, the advertiser quiz sub-module may be a standalone module within the interactive VR system that is not a sub-module of the reward wallet module 112. The advertiser quiz platform can operate similarly to the educational award system sub-module. The digital unit wallet of reward wallet module 112 can store digital units corresponding to real-currency earned by users via the advertiser quiz platform. Digital units earned via the advertiser quiz platform can be subject to similar vesting schedule requirements as discussed above.

According to some embodiments, the advertiser quiz platform may include quizzes developed by a system administrator of system 100. In some embodiments, the advertiser quiz platform can include quizzes developed by advertisers. As a non-limiting example, an advertiser may create a quiz about the different flavors of a consumer good the advertiser markets and sells.

In some embodiments, the advertiser quiz platform can enable advertisers to sponsor quizzes created by educators via the educational award system. The advertisement associated with a quiz can be an advertisement for a participating merchant within system 100. Alternatively, the advertisement may be an advertisement unrelated to a specific merchant. For example, the advertisement may be for a large consumer brand, a mall with multiple locations, a movie theater chain, a franchise, etc. According to some embodiments, the advertisement associated with the quiz may be a banner advertisement that contains information regarding the advertiser. In some embodiments, the advertisement associated with the quiz may be a video advertisement. Users may select an option to watch the video. In some embodiments, selecting to watch the video may provide the user with some benefit. For example, the user may earn an increased reward by watching a video.

### Government Distribution System Sub-Module

According to some embodiments, reward wallet module 112 includes a sub-module for implementing a government distribution system within the interactive VR system. Alternatively, the government distribution sub-module may be a standalone module within the interactive VR system that is not a sub-module of the reward wallet module 112. The government distribution system can enable a government entity such as a national government, local government, government department, etc. to distribute real-world currency funds to the digital unit wallet of users of the interactive VR app 122. Beneficially, the government distribution system can improve the case of distributing funds to users by relying on the digital wallet of users within interactive VR system, which are already linked to user's banking or payment information. In some embodiments, the government distribution system may include safeguards to ensure transactions comply with monetary regulation. Such monetary regulations can include, in non-limiting examples, anti-money laundering laws, income taxes, and tax laws or regulations.

In some embodiments, the government entity can distribute funds only to users within a specific geographical area. For example, the government distribution system can enable a government entity to distribute funds to remote populations without convenient access to banking institutions. Alternatively, the government entity may distribute funds to a specific group of users. For example, the government distribution system may enable a government entity to distribute funds to users located in an area that recently experienced a natural disaster, or to distribute funds to a refugee camp or an organization assisting people within a geographic area.

In some embodiments, the government distribution system may enable a government to distribute funds to merchants. The government distribution system may distribute funds to business locations in a specific area. Alternatively, the government distribution system may disburse funds for small business loans. The government distribution system may facilitate the government entity collecting payments due for such loan.

According to some embodiments, the government entity can disburse funds to specific users based on targeted demographics. Targeted demographics can include, for example, zip code, income, family size, number of dependents, user participation in certain programs, etc. For example, users may enroll in certain training programs and register to be eligible to receive funds distributed through specified government benefit programs. In some embodiments, the government distribution system may enable a government entity to disburse consumer loans to users that request and qualify for such loan. The government distribution system may facilitate the government entity collecting payments due for such loan over time, including interest due.

The government distribution system can, in some embodiments, reward desirable user behavior. For example, the government distribution system may offer rewards for certain behaviors. Such behaviors can include, for example, user participation in community service events, healthcare visits, athletic events, cultural events, etc. To monitor participation and user behavior, the government distribution system can rely on users scanning QR or RFID codes at specified locations with their user device, similarly to system 100 above. For example, where a government entity wants to encourage participation in a community event to pick up garbage in a specific area, the government entity may offer a reward to users that can be collected by users scanning a QR code after dropping a bag of garbage in a specified location. The reward may be offered to users in an interactive VR map displayed to users on a user device 120 within system 100.

### Collectible Item Sub-Module

According to some embodiments, reward wallet module 112 includes a sub-module for collecting virtual items within the interactive VR system. Alternatively, the collectible item sub-module may be a standalone module within the interactive VR system that is not a sub-module of the reward wallet module 112. Users can collect virtual items that can be stored within a digital wallet, traded with other users, and/or auctioned off for profit. In some embodiments, users can collect the virtual items by visiting one or more real-world locations associated with the virtual items, such as a merchant location.

In some embodiments, collectible virtual items may be displayed in the wallet in any virtually-enabled visual form, such as cards, tokens, cans, plants, animals, human avatars, brands, or any combination thereof. In some embodiments, virtual basketball players may be displayed at various merchant locations, and users may visit the merchant locations to collect virtual cards associated with the virtual basketball players. Each virtual card may display information such as the player's name, likeness, team, and/or position, the card's rarity, etc. In some embodiments, rewards may be distributed to users based on the number of virtual cards collected in a user's digital wallet. For example, users who collect a full team of players may receive a ticket to an upcoming basketball game. Users may trade, auction, and/or bid on virtual cards to assemble a desired collection of cards.

In some embodiments, collectible virtual items may store virtual products and/or images and can be redeemed as such. In some embodiments, collectible virtual items can be redeemed as tokenized assets, via QR codes, and/or in exchange for another type of reward (e.g., a real-world product).

The collectible item system can enable a merchant to distribute real-world currency funds to the digital unit wallet of users of the interactive VR app 122. Beneficially, the collectible item system can incentivize users to visit real-world locations associated with the advertising campaign to draw in potential customers. Users are incentivized to engage with other users of the interactive VR app 122 to trade and/or auction collectible items for rewards.

In some embodiments, the collectible item system can distribute rewards only to users within a specific geographical area. For example, the collectible item system can enable a merchant to distribute rewards to users to visit a specific retail location. Alternatively, the collectible item system can distribute rewards to a specific group of users. For example, the collectible item system may enable a merchant to distribute bonus rewards to the most active users, and/or users who have collected the greatest number of collectible items.

The collectible item system can, in some embodiments, reward desirable user behavior. For example, the collectible item system may offer rewards for certain behaviors. Such behaviors can include, for example, user participation in sporting events, collection of a certain number of collectible items, visiting a certain number of retail locations, etc. To monitor participation and user behavior, collectible item system can rely on users scanning QR or RFID codes at specified locations with their user device, similarly to system 100 above. For example, where a merchant wants to encourage participation in a sporting event to bring attention to a basketball game, the merchant may offer an exclusive collectible card as a reward to users who attend the game. The reward can be collected by users scanning a QR code after arriving at the sporting event. The reward may be offered to users in an interactive VR map displayed to users on a user device 120 within system 100.

### Computer Systems and Networks

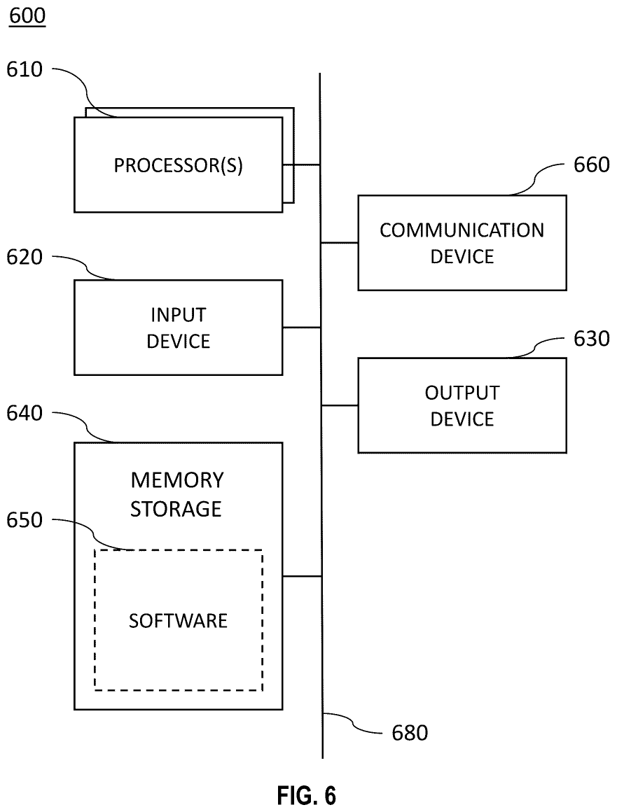

FIG. 6 illustrates an example of a computing device or system in accordance with one embodiment. Device 600 can include any previously mentioned computing device, such as a computing device of merchant system 114 of FIG. 1, or user devices 120 of FIG. 1. Device 600 can be a host computer connected to a network. Device 600 can be a client computer or a server. As shown in FIG. 6, device 600 can be any suitable type of microprocessor-based device, such as a personal computer, workstation, server or handheld computing device (portable electronic device) such as a phone or tablet. The device 600 can include, for example, one or more processor(s) 610, input devices 620, output devices 630, memory or storage devices 640, and communication devices 660. Software 650 residing in memory or storage device 640 may comprise, e.g., an operating system as well as software for executing the methods described herein. Input device 620 and output device 630 can generally correspond to those described herein, and can either be connectable or integrated with the computer.

Input device 620 can be any suitable device that provides input, such as a touch screen, keyboard or keypad, mouse, or voice-recognition device. Output device 630 can be any suitable device that provides output, such as a touch screen, haptics device, or speaker.

Storage 640 can be any suitable device that provides storage (e.g., an electrical, magnetic or optical memory including a RAM (volatile and non-volatile), cache, hard drive, or removable storage disk). Communication device 660 can include any suitable device capable of transmitting and receiving signals over a network, such as a network interface chip or device. The components of the computer can be connected in any suitable manner, such as via a wired media (e.g., a physical system bus 680, Ethernet connection, or any other wire transfer technology) or wirelessly (e.g., Bluetooth®, Wi-Fi®, or any other wireless technology).

Software module 650, which can be stored as executable instructions in storage 640 and executed by processor(s) 610, can include, for example, an operating system and/or the processes that embody the functionality of the methods of the present disclosure (e.g., as embodied in the devices as described herein).

Software module 650 can also be stored and/or transported within any non-transitory computer-readable storage medium for use by or in connection with an instruction execution system, apparatus, or device, such as those described herein, that can fetch instructions associated with the software from the instruction execution system, apparatus, or device and execute the instructions. In the context of this disclosure, a computer-readable storage medium can be any medium, such as storage 640, that can contain or store processes for use by or in connection with an instruction execution system, apparatus, or device. Examples of computer-readable storage media may include memory units like hard drives, flash drives and distribute modules that operate as a single functional unit. Also, various processes described herein may be embodied as modules configured to operate in accordance with the embodiments and techniques described above. Further, while processes may be shown and/or described separately, those skilled in the art will appreciate that the above processes may be routines or modules within other processes.

Software module 650 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic or infrared wired or wireless propagation medium.

Device 600 may be connected to a network (e.g., network 130, as shown in FIG. 1 and/or described below), which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 600 can be implemented using any operating system, e.g., an operating system suitable for operating on the network. Software module 650 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example. In some embodiments, the operating system is executed by one or more processors, e.g., processor(s) 610.

For the purpose of clarity and a concise description, features are described herein as part of the same or separate embodiments; however, it will be appreciated that the scope of the disclosure includes embodiments having combinations of all or some of the features described.

### Additional Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

1. A method for deploying an interactive virtual-reality campaign and monitoring analytics associated with the campaign, the method comprising:
displaying, on a computing device accessible to a merchant, a graphical user interface;
detecting a first user input on the graphical user interface, wherein the first user input specifies an interactive activity associated with the campaign;
detecting a second user input on the graphical user interface, wherein the second user input specifies one or more of a time metric, a location metric, a display metric, and a reward metric;
transmitting, based on the first user input and the second user input, one or more campaign instructions for rendering a virtual-reality visualization associated with the campaign on one or more user devices;
receiving, from the one or more user devices, user engagement data associated with the campaign based on user engagement with the virtual-reality visualization; and
generating, using the graphical user interface, one or more analytics visualizations associated with the campaign based on the user engagement data.

2. The method of claim 1, wherein the interactive activity comprises one or more of: interacting with an icon, playing a virtual-reality game, collecting a virtual-reality reward, viewing an advertisement, visiting a map location, scanning a visual code, responding to a poll, and responding to a quiz.

3. The method of claim 1, wherein the interactive activity is associated with a real-world location.

4. The method of claim 1, further comprising: detecting a third user input on the graphical user interface, wherein the third user input specifies a target demographic of the campaign.

5. The method of claim 4, wherein transmitting the one or more campaign instructions comprises transmitting, based on the first user input, the second user input, and the third user input, the one or more campaign instructions to one or more user devices associated with the target demographic.

6. The method of claim 1, wherein the time metric comprises one or more of: a daypart, a campaign start date, a campaign end date, a campaign start time, a campaign end time, a reward collection start time, and a reward collection end time.

7. The method of claim 1, wherein the location metric comprises one or more of: a map location, a merchant location, a visit limit for a location, a reward limit for a location, a latitude, a longitude, and a radius for reward collection.

8. The method of claim 1, wherein the display metric comprises one or more of: an icon representing the campaign, text representing the campaign, an icon representing the activity, text representing the activity, a visual code, a notification, a countdown for a time limit, a timer, and a map.

9. The method of claim 1, wherein the reward metric comprises one or more of: a reward type, a reward trigger, a follow-up reward, a reward price, a reward quantity, a reward to be provided to a user based on past purchasing behavior of the user, and a conversion rate between rewards and currency.

10. The method of claim 1, wherein the virtual-reality visualization associated with the campaign comprises at least a portion of one or more of: an advertisement, a map, a user icon, a merchant icon, a virtual-reality game, a poll, a quiz, a virtual-reality scavenger hunt, an interactive character, a collectible item, a digital wallet, a currency icon, a reward icon, a collectible icon, and a coupon.

11. The method of claim 1, wherein the second user input specifies an image to be uploaded, and wherein the image represents one or more of the campaign and a reward associated with the campaign.

12. The method of claim 1, further comprising: updating one or more of the time metric, the location metric, the display metric, and the reward metric based on the user engagement data.

13. The method of claim 1, further comprising:
detecting a fourth user input on the graphical user interface, wherein the fourth user input is associated with selecting an analytics visualization of the one or more analytics visualizations associated with the campaign; and
displaying, on the computing device accessible to the merchant, the selected analytics visualization based on the fourth user input.

14. The method of claim 1, wherein the one or more analytics visualizations comprise one or more of: a map, a graph, a table, a list, and a statistic.

15. The method of claim 1, wherein the user engagement data comprises one or more of: user time data, user location data, user purchase data, and user reward data.

16. The method of claim 15, wherein the user time data comprises one or more of: time spent at a map location, frequency of visits to the map location, time spent walking between map locations, and time spent engaging with the interactive activity associated with the campaign.

17. The method of claim 15, wherein the user location data comprises one or more of: number of visits to a map location, number of visits to new locations, and ratio of new visits to returning visits.

18. The method of claim 15, wherein the user purchase data comprises one or more of: number of purchases at a map location, total profit from the purchases, and average cost of the purchases.

19. The method of claim 15, wherein the user reward data comprises one or more of: number of rewards awarded, number of the rewards left over, type of the rewards awarded, and value of the rewards awarded.

20. The method of claim 1, further comprising:
detecting a fifth user input on the graphical user interface, wherein the fifth user input is associated with inputting a user access credential of the merchant; and
verifying the access level of the merchant.

21. The method of claim 20, further comprising: if the access level exceeds a threshold access level, displaying, on the computing device accessible to the merchant, one or more additional analytics visualizations associated with a plurality of interactive virtual-reality campaigns.

22. The method of claim 21, wherein the one or more additional analytics visualizations comprise one or more of: a budget breakdown for each campaign of the plurality of interactive virtual-reality campaigns, identifying information associated with the one or more user devices, a list of transactions associated with each campaign of the plurality of interactive virtual-reality campaigns, summary statistics for the plurality of interactive virtual-reality campaigns, and a ranking of the plurality of interactive virtual-reality campaigns.

23. A computer-based system for deploying an interactive virtual-reality campaign and monitoring analytics associated with the campaign, the system comprising:
a computing device accessible to a merchant;
one or more user devices; and
one or more processors coupled to one or more memory devices, wherein the one or more memory devices include instructions that when executed by the one or more processors cause the computer-based system to:
display, on the computing device, a graphical user interface;
detect a first user input on the graphical user interface, wherein the first user input specifies an interactive activity associated with the campaign;
detect a second user input on the graphical user interface, wherein the second user input specifies one or more of a time metric, a location metric, a display metric, and a reward metric;
transmit, based on the first user input and the second user input, one or more campaign instructions for rendering a virtual-reality visualization associated with the campaign on the one or more user devices;
receive, from the one or more user devices, user engagement data associated with the campaign based on user engagement with the virtual-reality visualization; and
generate, using the graphical user interface, one or more analytics visualizations associated with the campaign based on the user engagement data.

24. The computer-based system of claim 23, wherein the one or more user devices comprise one or more processors coupled to one or more memory devices, wherein the one or more memory devices include instructions that when executed by the one or more processors cause the one or more user devices to:
receive the one or more campaign instructions for generating the virtual-reality visualization associated with the campaign;
render, based on the one or more campaign instructions, an interactive virtual-reality environment comprising the virtual-reality visualization;
collect, based on user engagement with the virtual-reality visualization, the user engagement data associated with the campaign; and
transmit, to the computing device, the user engagement data associated with the campaign.

25. A non-transitory machine-readable medium for deploying an interactive virtual-reality campaign and monitoring analytics associated with the campaign, the non-transitory machine-readable medium storing instructions that, when executed by at least one processor of a computing device, cause the computing device to perform operations comprising:
displaying a graphical user interface;
detecting a first user input on the graphical user interface, wherein the first user input specifies an interactive activity associated with the campaign;
detecting a second user input on the graphical user interface, wherein the second user input specifies one or more of a time metric, a location metric, a display metric, and a reward metric;
transmitting, based on the first user input and the second user input, one or more campaign instructions for rendering a virtual-reality visualization associated with the campaign on one or more user devices;
receiving, from the one or more user devices, user engagement data associated with the campaign based on user engagement with the virtual-reality visualization; and
generating, using the graphical user interface, one or more analytics visualizations associated with the campaign based on the user engagement data.
